(19) United States
(12) Patent Application Publication
(10) Pub. No.: US 2023/0281564 A1
(43) Pub. Date: Sep. 7, 2023

(54) SYSTEM AND METHOD FOR MANAGING DATA IN A PLATFORM

(71) Applicant: HireTeamMate, Inc., Mountain View, CA (US)

(72) Inventors: Hongtao ZHANG, Santa Clara, CA (US); Hanfei MEI, Redmond, WA (US); Bowen WAN, Sunnyvale, CA (US)

(21) Appl. No.: 17/686,120

(22) Filed: Mar. 3, 2022

(51) Int. Cl. G06Q 10/10; G06Q 10/06

(52) U.S. Cl. CPC G06Q 10/1053; G06Q 10/063112

(57) ABSTRACT

A system for extracting relevant candidate data from a database of multiple candidate profiles is provided. The system is configured to receive an input profile and parse it into standardized profile data. The system is further configured to search the database to identify one or more related profiles for the standardized profile data. Further, the system is configured to use either or a combination of a trained machine learning model or a rule-based model to compute a similarity score between each of the related profiles and the standardized profile data. The similarity score is then used to output a matched profile from the one or more related profiles as the extracted candidate profile from the database.

### FIELD

The present disclosure generally relates to data handling and management in a platform, and more particularly relates to systems and methods for managing talent data in a platform.

### BACKGROUND

Talent data management is a pervasive field that finds relevance and utility in all industrial, technical, medical, educational, and government or regulatory sectors. Scouting for right talent, which is best fit for a requirement within an organization, be it from any of the sectors mentioned above, is a key task as well as challenge for talent management professionals associated with the organization. This is not only a time-consuming task, but many times is also one of the most unproductive tasks that talent management professionals have to perform. The reason behind this is the unsurety of outcome of the scouting process, which is to say, whether candidate data or candidate profiles that the talent management professionals are gathering, viewing, analyzing, and shortlisting are actually best fit or not, is very uncertain. Further, with numerous data channels, such as job postings, referrals, professional networks, social networks, job boards and the like, talent management professionals are inundated with a large volume of data of candidate profiles, with very less time and computing resources available at their hands.

Some web portals have tried to address the aforementioned problems by providing aggregation of candidate data from a plurality of sources and further filtering of the candidate data based on some predefined criteria. But mostly the aggregation and filtering of such data has been inefficient, leading to inappropriate candidate profiles being shortlisted, and relevant candidate profiles being ignored in many cases. Some solutions have also tried to automate the process of gathering and extracting suitable candidate data by the use of advanced computing techniques such as Artificial Intelligence (AI), but these automations have largely been very tedious to implement and result in providing outdated or stale candidate data in many instances, due to infrequent updates of data and algorithms used in such computing techniques.

Another challenge with aggregation of candidate profiles from multiple sources is that that a redundancy in the acquired data may exist. For instance, the acquired data may include multiple profiles for a single candidate, as aggregate from different sources. Accordingly, there might be challenges in maintaining a database and identifying a dependable (most updated) profile of the candidate, which is most relevant for an organization and can be quickly and efficiently accessed by the talent management professional. At the same time, the data accessed by the talent management professionals should be securely stored, such as on a platform, so that only the talent management professional of the organization of interest can only access the desired candidate data.

Thus, there is a need to overcome the challenges of inefficient, outdated, less secure and inaccurate candidate data management technologies, in order to provide high quality, accurate, secure, and reliable data for talent management professionals.

### SUMMARY

It is an objective of some of the example embodiments disclosed herein to provide efficient solutions to the problems and challenges discussed above. More specifically, it is an objective of the various embodiments disclosed herein to provide efficient aggregation, analysis, storage, management, and security for candidate data extracted from the plurality of data sources for talent management applications.

Various embodiments disclosed herein provide effective data management in a data platform, such as a talent data management platform. The platform provides efficient, secure, accurate and productive data management by using up-to-date and targeted computational system, based on advanced computing techniques such as AI, machine learning, and rule-based processing.

Some embodiments provide methods and systems for searching one or more candidate profiles in a data management platform, such as a talent acquisition platform, such that the one or more candidate profiles are similar to an input profile. To ensure these one or more searched candidate profiles are similar to the input profile, similarity between the input profile and the one or more candidate profiles is identified based on AI based on rule-based models.

Some embodiments provide methods and systems for building a private talent pool for a user associated with the data management platform, such redundancy of data in the data management platform is reduced, while at the same time, data is securely maintained in the platform for each and every customer. The user may be such as a customer of the data management platform. The private talent pool of the customer is formed on the basis of candidate data profiles that are different from public profiles available on public data sources. This ensures availability of up-to-date candidate data, data privacy, and security from data breach threats.

In one aspect, a system for extracting candidate data from a database storing a plurality of candidate profiles is disclosed. The system comprises: an input interface configured to receive an input profile data, a memory configured to store computer-executable instructions and at least one processor configured to execute the computer-executable instructions. The computer executable instructions configured to: parse the input profile data into a standardized profile data format. The computer executable instructions further configured to determine a first set of profile data from the plurality of candidate profiles by searching in the database. The first set of profiles being related to the standardized profile data. Further, a similarity score for each profile data in the first set of profile data is computed by either or a combination of: (i) a trained Machine Learning (ML) model or (ii) a rule-based model. The similarity score is associated with a measure of similarity between the standardized profile data and each respective profile data in the first set of profile data. The computer executable instructions further configured to extract matched profile data from the first set of profile data based on a comparison of the similarity score with a threshold confidence score. The matched profile is then output as the extracted candidate profile on an output interface associated with the system.

Additionally, the system is configured to compute the similarity score by determining a structure of the standardized profile data, wherein the structure of the profile data is at least one of a simple structure and a complex structure. The determined structure is then used for computing the similarity score by either or a combination of: (i) a trained Machine Learning (ML) model, (ii) a rule-based model. The rule-based model comprises one or more computer-executable rules for determining a level of similarity of each respective profile data with the standardized profile data. The trained ML model comprises a computer-executable ML model stored in the memory. The ML model is trained using a training dataset of profile data, which is derived from the plurality of candidate profiles stored in the database and the outputted matched profile.

In additional system embodiments, extracting the matched profile comprises comparing the similarity score of each respective profile data of the first set of profile data with the threshold confidence score. Further a respective profile data with the similarity score greater than the threshold confidence score is extracted as the matched profile

In additional system embodiments, a respective profile from the first set of profile data is removed when the similarity score of the respective profile is lesser than the threshold confidence score.

In additional system embodiments, the standardized profile data format comprises one or a combination of data fields selected from: a name of a person, location of the person, designation of the person, working period of the person, education of the person, contact details of the person, age of the person, and gender of the person.

In additional system embodiments, system is configured to identify a customer inputting the input profile data. Further a first set of data fields associated with the standardized profile data and a second set of data fields associated with the matched profile data are determined. The first set of data fields is then compared with the second set of data fields using the trained ML model. Further, a private talent pool of data for the customer in the database is created, when the comparison indicates a difference in the first set of data fields and the second set of data fields.

In another aspect, a method for extracting candidate data from a database storing a plurality of candidate profiles is provided. The method comprises receiving, at an input interface, an input profile data. The method further comprises parsing the input profile data into a standardized profile data format. The method additionally comprises determining a first set of profile data from the plurality of candidate profiles by searching in the database. The first set of profile data being related to the standardized profile data. Further, using either or a combination of: (i) a trained Machine Learning (ML) model or (ii) a rule-based model, a similarity score for each profile data in the first set of profile data is computed. The similarity score is associated with a measure of similarity between the standardized profile data and each respective profile data in the first set of profile data. Based on a comparison of the similarity score with a threshold confidence score, a matched profile data is extracted. The matched profile data is outputted as the extracted candidate profile at an output interface.

In yet another aspect, a computer program product comprising a non-transitory computer readable medium having stored thereon computer executable instructions is provided. The computer executable instructions, when executed by at least one processor, cause the at least one processor to carry out operations for extracting candidate data from a database storing a plurality of candidate profiles, the operations comprising: receiving, at an input interface, an input profile data; parsing the input profile data into a standardized profile data format; determining, by searching in the database, a first set of profile data from the plurality of candidate profiles, that is related to the standardized profile data; computing, by either or a combination of: (i) a trained Machine Learning (ML) model or (ii) a rule-based model, a similarity score for each profile data in the first set of profile data, such that the similarity score is associated with a measure of similarity between the standardized profile data and each respective profile data in the first set of profile data; extracting matched profile data from the first set of profile data based on a comparison of the similarity score with a threshold confidence score; and outputting, at an output interface, the matched profile data as the extracted candidate profile.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram showing a network environment of a system for managing data in a data management platform, in accordance with one or more example embodiments;

FIG. 2A illustrates a block diagram of the data management platform, in accordance with one or more example embodiments;

FIG. 2B illustrates another block diagram showing a similarity computation module associated with the data management platform of FIG. 2A, in accordance with one or more example embodiments;

FIG. 3A illustrates a flowchart of a method for managing data in the data management platform of FIG. 2A, in accordance with one or more example embodiments;

FIG. 3B illustrates another flowchart of a method for managing data in the data management platform of FIG. 2A, in accordance with one or more example embodiment;

FIG. 4 illustrates a GUI depicting different fields associated with an input profile, in accordance with one or more example embodiments;

FIG. 5 illustrates a flowchart of a method for creating a private talent pool of data for a customer of the data management platform based on fields comparison, in accordance with one or more example embodiments;

FIGS. 6A-6C illustrate graphical user interfaces (GUIs) depicting sample profile data stored in the data management platform shown in FIG. 2A, in accordance with one or more example embodiments; and

FIG. 7 illustrates a block diagram of a computing system used for implementation of the system discussed in previous figures for data management, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for managing data in a data management platform. The data management platform may be a talent acquisition platform and the data may be talent data related to candidates for talent opportunities. Talent opportunities may refer to job vacancies in organizations, institutions, healthcare facilities, government bodies, and the likes in any industry. The data management platform may be accessed by a customer, such as talent management professional, for scouting for candidates for their organization, and also for storing candidate data for employees in their own organization or job seeker candidates. The customer in this manner may be embodied as a business customer or an organization, desirous of managing their talent data using the data management platform.

The systems and methods disclosed herein provide efficient, dependable, secure, and accurate data management for the customers of the data management platform through the use of computationally efficient similarity scoring and profile matching techniques. Further, some embodiments disclose generation of private talent pool of data for the customers based on ML based data duplication checking. This provides security, data isolation, safety from data breach, and privacy of data for the customers, especially since talent data mostly contains a lot of personal and professional details of candidates, which needs to be managed safely. At the same time, deduplication of data by creating private talent pools helps to reduce redundancy in data wherever possible and saves a lot of memory space that would otherwise have been wasted by storing multiple copies of same data.

Various embodiments provide efficient scoring methodologies for providing right candidate data to the customers, such as the talent data management professionals and Human Resource (HR) managers, helping them increase the productivity and efficiency of overall hiring processes. Also the time saved by talent data management professionals while identifying relevant candidates by the use of the systems and methods disclosed herein can be used for enhancing the actual human experience of a hiring process, interaction between a job candidate and the talent management professional. Thus, the various systems and methods disclosed herein use efficient ML based technologies to enhance the quality of hires, reduce time in aggregating relevant data from numerous data sources, identifying best match profiles from a number of shortlisted candidate profiles, and reducing time to on-board right candidates to right organizations.

These and various other advantages of the systems and methods disclosed herein will be apparent from the detailed description provided herein, in conjunction with the various accompanying figures described below.

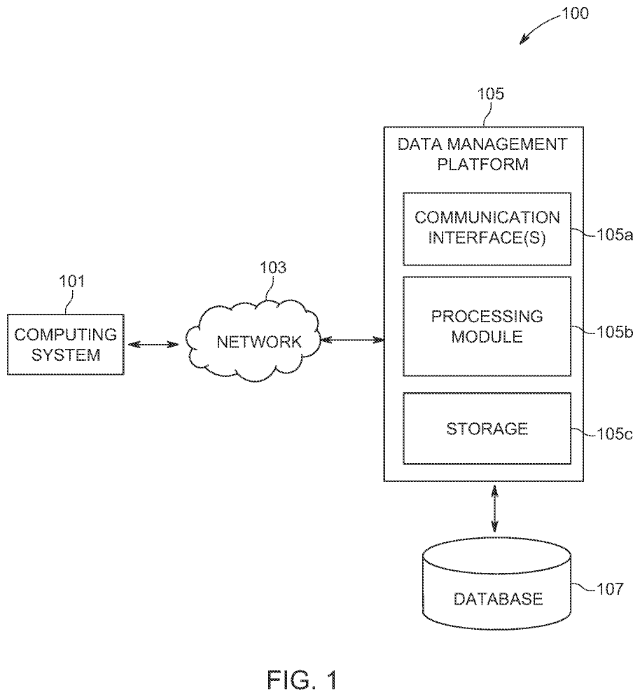

FIG. 1 illustrates a block diagram showing a network environment 100 of a system for managing data in a data management platform 105, in accordance with one or more example embodiments. The data management platform 105 may be embodied as the system which manages data related to various users or customers, candidates (such as job seekers), and talent management professionals. The network environment 100 comprises a computing system 101 in communication with the data management platform 105 over a communication network 103. The data management platform 105 may also be associated with an external database 107, which may store data about a plurality of profiles.

A candidate may be a job seeker, an active job applicant who is actively looking for a job, a passive job candidate who is not actively looking for a job or may even be simply employee of an organization. A profile may include information about the candidate and may be referred to interchangeably as a candidate profile. The candidate profile may be organized in the form of multiple fields which give information about the user, such as the candidate. The multiple fields may include such as name, age, gender, qualifications, experience, nationality, contact details, public profile link, website link, skills information, and the like. The candidate profile may be submitted by candidates themselves or may be obtained from candidates through use of forms or applications. A plurality of such candidate profiles may be received in various forms from a plurality of candidates, such as in the form of a resume, a document with multiple data fields, a form submitted from a website, a profile corresponding to a job description in talent acquisition industry and the like. These plurality of candidate profiles may be stored in the database 107 associated with the data management platform 105.

The data management platform 105 may be embodied as a system for managing data associated with profiles stored in the database 107. More specifically, system in the form of the data management platform 105 may be used for extracting candidate data from the database 107 storing the plurality of candidate profiles.

The data management platform 105 comprises one or communication interfaces 105a for exchanging data with the computing system 101 and the database 107, and also other entities external to the data management platform 105. The one or communication interfaces 105a include at least an input interface and an output interface. The input interface may be configured to receive an input profile data, such as profile data of a user.

The input profile data may be received from one or more sources such as from a user, from a public forum, from a social networking portal, from a professional networking portal, from an email account, from direct submission by a candidate on the data management platform 105, from a web crawler that crawls public profiles on the web, and the like. In some embodiments, the input profile is related to talent acquisition data managed by the data management platform 105 for a customer. In that sense, the input profile is a candidate profile of a job opportunity related candidate.

The input profile may be received in any of a number of possible formats, such as, in the form of a resume document, a job description related submission document, a form submitted on a job portal or website, a direct submission entry made on the data management platform and the like. For example, a user may access their computing system 101 and using that, open or browse to a web page that may be the landing page for a website hosted by the data management platform 105. Then, the user selects an option for entering an input profile and its data, on the web page, and a form having different fields requiring user input may open up. These different fields may be configured for gathering information about the input profile, and may include fields such as name, years of experience, gender, technical skills, age, past organization, location, current salary, current designation/role, and the like. In some embodiments, the user may directly enter or upload a resume as the input profile data.

The input profile may be parsed by the data management platform 105, to convert it to a standardized profile data format. The standardized profile data format provides identifiable information corresponding to the input profile, which is represented by using one or more standardized fields. Each input profile is converted to a corresponding unique standardized profile by having its unique standardized profile data format. In some embodiments, parsing of the input profile data into the standardized profile data format is done by using a Named Entity Recognition (NER) model. However, other technologies for data parsing may also be used, such as sentiment analysis, text summarization, aspect mining, topic modeling, and the like, without deviating from the scope of the present disclosure. The standardized profile format may include data fields such as name of a person, location of the person, designation of the person, working period of the person, education of the person, person information (such as contact details, age, gender etc.,), and the like.

Once the input profile is parsed as the standardized profile, the standardized profile may be used to search in the database 107, a first set of profile data from the plurality of candidate profiles stored in the database 107, such that each profile in the first set of profile data is related to the standardized profile data using the input profile as a search criteria.

The standardized profile data providing the identifiable information may be inputted into a search engine hosted by the data management platform 105. The search engine identifies, from the database 107, the one or more profiles related to the searched profile (that is the input profile in standardized format). The identified one or more profiles form the first set profile data, in which the one or more profiles are then arranged based on a ranking information. The ranking information provides an order of priority for various data fields in the standard profile data format. For instance, a first set of data fields (e.g. full name, social links, emails, or the like) may be provided with highest priority, and a second set of data fields (e.g. current company name, past company names, educational institutes, location, or the like) may be provided with lowest priority and the like. Based on the order of priority, the search engine outputs the one or more profiles that were identified during search.

Once the search results have been organized by ranking, a similarity score is calculated between each profile data in the first set of profile data and the standardized profile data. The similarity score gives a measure of similarity between the standardized profile data and each respective profile data in the first set of profile data. The profiles from the first set that are ranked already and are more similar to the standardized profile are given higher score, while less similar profiles are given lower scores. In some embodiments, the similarity score is a numerical value between 0 and 1, such that a similarity score value of 0.2 indicates lesser similarity as compared to a similarity score value of 0.8. Therefore, the similarity score indicates a confidence level in the respective profile from the first set, for its similarity with the standardized profile data of the input profile. The similarity score for each respective profile is computed by using either or a combination of: (i) a trained Machine Learning (ML) model or (ii) a rule-based model. The computation is conducted on the basis of structure of the input profile data. If the structure indicates more complexity, then the trained ML model is used, while if the structure indicates lesser complexity (that is to say, if the input profile includes less information), the rule-based model is used. For instance, if the structure of the input profile is simple the rule-based model may be selected. In the rule-based model, a set of rules may be executed to output a confidence score for each of the one or more profiles in the first set of profiles identified during search.

Alternatively, when the verification is performed by the ML model(s), the ML model may also output the confidence score for each of the one or more profiles in the first set of profiles upon receiving the one or more profiles and the input profile.

Further, the ML models (or the rule-base model) may compare the similarity score of each respective profile in the first set of profiles with a threshold confidence score. Based on the comparison, matched profile data may be extracted from the first set of profile data. If the confidence score of a particular profile is greater than the threshold confidence score, then that particular profile may be similar to the input profile. However, if the confidence score of a particular profile is lesser than the threshold confidence score, then that particular profile may not be similar to the input profile and may be removed from the first set of profiles (that is the set of ranked search results) so that it is not used for further processing. The threshold confidence score may be a configurable numerical value, which may be set based on a number of constraints, such as range of similarity score, historical similarity score values, historical data about similar profiles, experimental data verification performed offline, and the like. For instance, a threshold confidence score value of 0.7 may indicate that profiles with similarity score greater than or equal to 0.7 will be considered matched profiles that are similar to the input profile. On the other hand, the profiles with similarity score lesser than 0.7 will be considered un-matched profiles that are not similar to the input profile and can be removed from further processing.

Furthermore, the ML models may remove profile(s) from the one or more profiles to reduce the redundancy, based on the comparison results. Alternatively, a user may select, based on the comparison results, the profile(s) from the one or more profiles to remove the selected profile(s). Additionally, this user selection can be used to train the ML models.

Thus, once the one or more profiles are outputted from the search engine, the one or more profiles may be verified against the input profile to check if the one or more profiles are similar to the input profile by using the similarity score and threshold confidence score computations discussed above.

Once the matched profile data is identified in the manner described above, the matched profile data may be outputted on an output interface of the data management platform 105, such as on the communication interface 105a. In some embodiments, the matched profile data comprises all the profiles from the first set of profile data that qualify the threshold confidence score comparison check, and all these profiles may be outputted on the output interface of the communication interface 105a. However, in some embodiments, the matched profile data comprises one or more profiles with highest similarity score values, from the profiles which have similarity score higher than the threshold confidence score, and only these profiles are then outputted on the output interface of the communication interface 105a. The outputted one or more profiles this form the extracted candidate profiles from the database 107 that may be used by the user or the customer of the data management platform 105 for further consideration.

In various embodiments, the paring of the input profile into the standardized profile data format, the searching of the first set of profiles, the computation of the similarity scores, the comparison of the similarity scores with the threshold confidence score and the outputting of the matched profile data are all effectuated by a processing module 105b or a processor, that is configured to execute one or more computer executable instructions related to management of data by the data management platform 105. The computer-executable instructions may be stored in a storage 105c, or a memory associated with the data management platform 105. The storage 105c also stores the rule-based model and the trained ML model in the form of computer-executable instructions specific to implementation of the rule-based model and the trained ML model respectively, when required. In addition the storage 105c may also store a training dataset of profile data that is derived from the plurality of candidate profiles (or just profiles) stored in the database 107, and the outputted matched profile. The storage 105c also stores a plurality rules in the form of computer-executable instructions for checking a plurality of conditions associated with the rule-based model.

In some embodiments, the rule-based model and the trained ML model may be stored in a cloud computing-based server, a remote server, or a virtual server that may be different from but is associated with the data management platform 105.

In some embodiments, the database 107 comprises the plurality of candidate profiles associated with talent acquisition data for a customer of the data management platform 105.

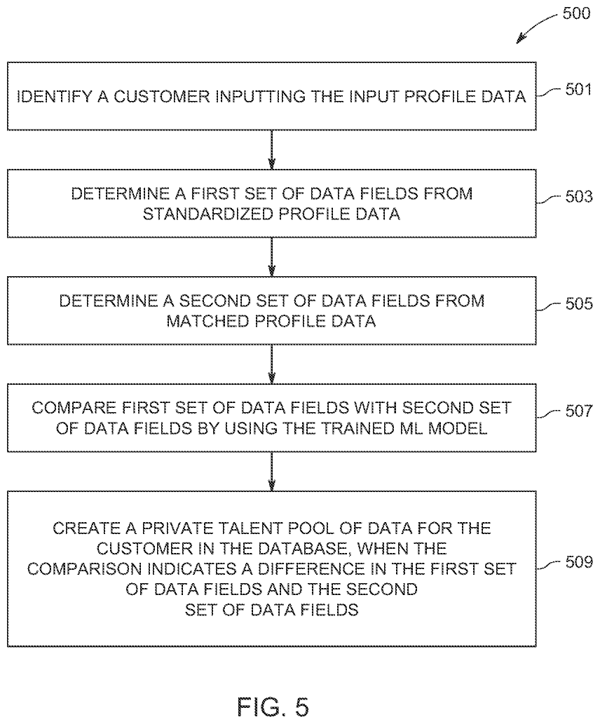

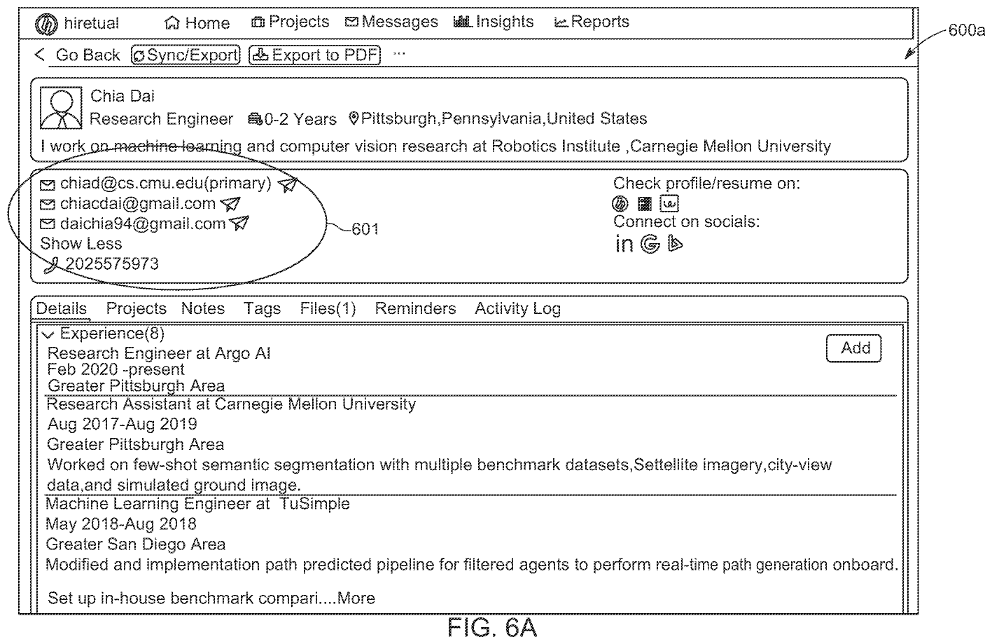

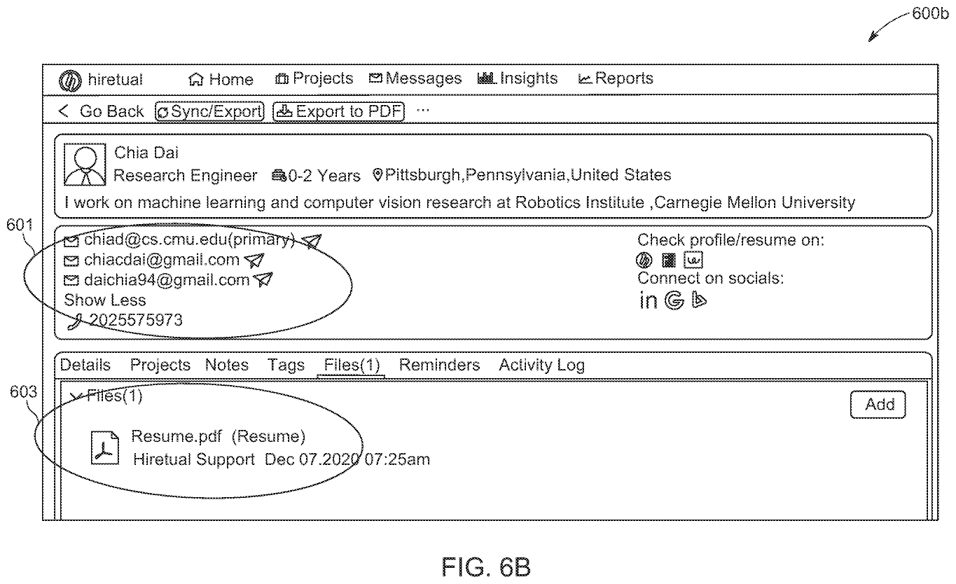

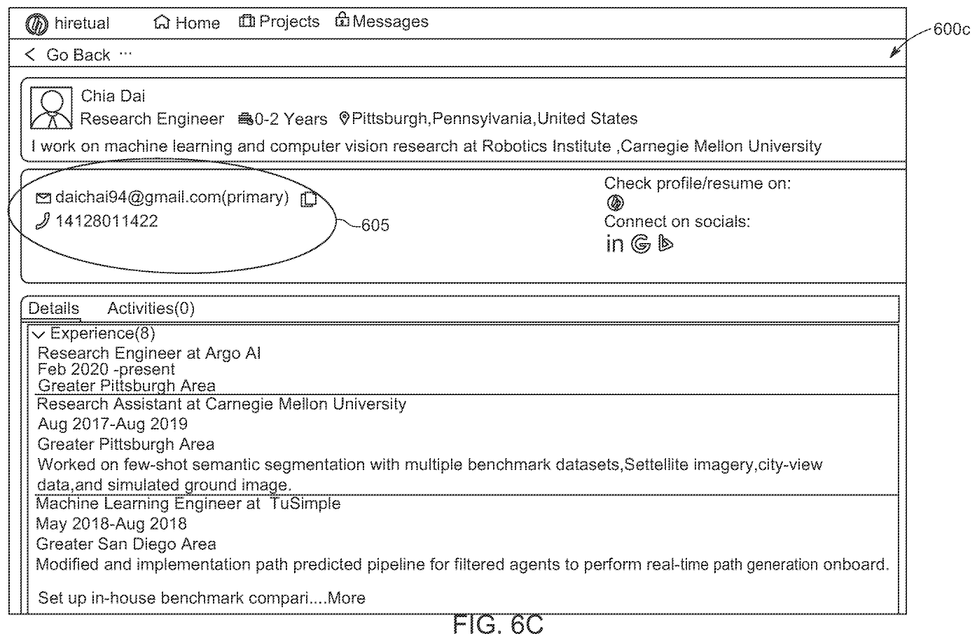

In some embodiments, the data management platform 105 is configured to generate a private talent pool of data for the customer for ensuring data isolation and privacy of each customer's data. To generate and maintain the private talent pool, whenever the customer inputs a profile to the data management platform 105, it is taken as the input profile received from that specific customer. Then the input profile is parsed, as already described above, and a first set of data fields associated with the standardized profile data of the input profile received from the customer is determined. Then, matched profile data for that input profile data is identified based on the techniques described above, and a determine a second set of data fields associated with the matched profile data are also determined. If the matched profile data has multiple matched profiles, then for each matched profile, the second set of fields is determined. Further, using the trained ML model, the first set of data fields is compared with the second set of data fields. Based on this comparison, a private talent pool of data for the customer is created in the database 107, when the comparison indicates a difference in the first set of data fields and the second set of data fields. The creation of private talent data pool will be further described in detail in conjunction with FIG. 5 and FIGS. 6A-6C described later.

Thus, using the embodiments described above, the data management platform 105 embodies the system for managing data, specifically candidate data for candidate data profiles stored in the database 107. The components described in the block diagram of the data management platform 105 may be further broken down into more than one component and/or combined together in any suitable arrangement. Further, it is possible that one or more components may be rearranged, changed, added, and/or removed without deviating from the scope of the present disclosure.

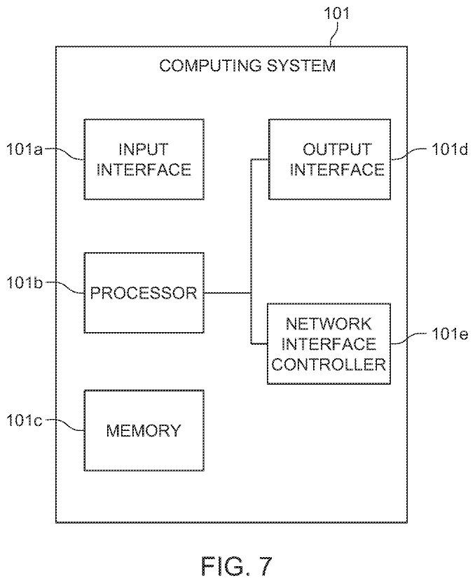

In an example embodiment, the data management platform 105 may be embodied in one or more of several ways as per the required implementation. For example, the data management platform 105 may be embodied as a cloud-based service, a cloud-based application, a cloud-based platform, a remote server-based service, a remote server-based application, a remote server-based platform, or a virtual computing system. As such, the data management platform 105 may be configured to operate inside the computing system 101. In some example embodiments, the computing system 101 may be any user accessible device such as a mobile phone, a smartphone, a portable computer, a personal computer, a laptop, a tablet, a phablet, a personal digital assistant (PDA), and the like. The computing system 101 may comprise a processor, a memory, and a communication interface. The processor, the memory, and the communication interface may be communicatively coupled to each other. The general architecture of the computing system 101 will be described in detail in FIG. 7. The computing system 101, the data management platform 105, and the database 107, may all be coupled communicatively via the communication network 103.

The communication network 103 may be wired, wireless, or any combination of wired and wireless communication networks, such as cellular, Wi-Fi, internet, local area networks, or the like. In one embodiment, the communication network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. The communication network 103 communicatively couples the computing system 101 used by the customer for accessing the services provided by the data management platform 105.

In some embodiments, the data management platform 105 is configured to extract and store various profiles in the database 107, such as candidate profiles, profiles from an organizations' Application Tracking System (ATS), profiles crawled from internet, and the like. To that end, the data about various profiles is parsed to the standardized format before storing in the database 107.

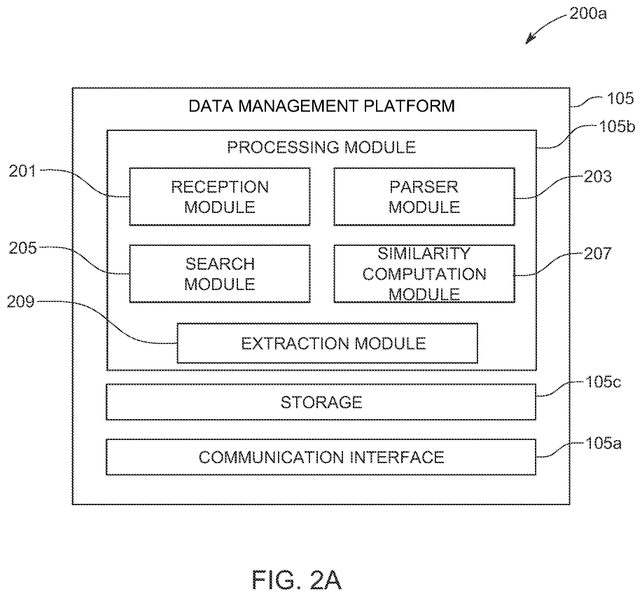

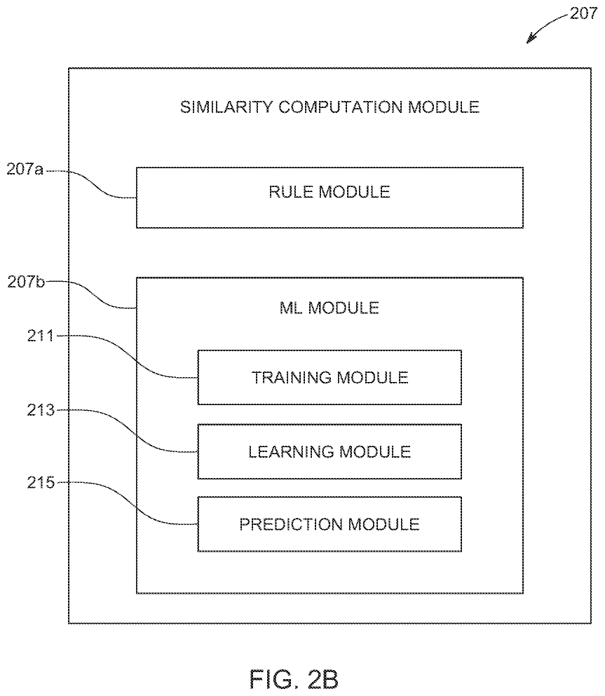

FIG. 2A illustrates a block diagram 200a of the data management platform 105, in accordance with one or more example embodiments. As illustrated, the data management platform 105 comprises at least one processor, such as a processing module 105b, which further comprises a plurality of modules. These plurality of modules may include a reception module 201, a parser module 203, a search module 205, a similarity computation module 207, and an extraction module 207.

The processing module 105b may be embodied in a number of different ways. For example, the processing module 105b may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing module 105b may include one or more processing cores configured to perform independently. A multi-core processor may enable multiprocessing within a single physical package. Additionally or alternatively, the processing module 105b may include one or more processors configured in tandem via the bus to enable independent execution of instructions, pipelining and/or multithreading.

Additionally or alternatively, the processing module 105b may include one or more processors capable of processing large volumes of workloads and operations to provide support for big data analysis. In an example embodiment, the processing module 105b may be in communication with a memory, such as the storage 105c via a bus for passing information. The storage 105c may be non-transitory and may include, for example, one or more volatile and/or non-volatile memories. In other words, for example, the storage 105c may be an electronic storage device (for example, a computer readable storage medium) comprising gates configured to store data (for example, bits) that may be retrievable by a machine (for example, a computing device like the processing module 105b). The storage 105c may be configured to store information, data, content, applications, instructions, or the like, for enabling the data management platform 105 to conduct various functions in accordance with an example embodiment of the present disclosure. For example, the storage 105c may be configured to buffer input data for processing by the processing module 105b. As exemplarily illustrated in FIG. 2A, the storage 105c may be configured to store instructions for execution by the processing module 105b. As such, whether configured by hardware or software methods, or by a combination thereof, the processing module 105b may represent an entity (for example, physically embodied in circuitry) capable of performing operations according to an embodiment of the present disclosure while configured accordingly. Thus, for example, when the processing module 105b is embodied as an ASIC, FPGA or the like, the processing module 105b may be specifically configured hardware for conducting the operations described herein. Alternatively, as another example, when the processing module 105b is embodied as an executor of software instructions, the instructions may specifically configure the processing module 105b to perform the algorithms and/or operations described herein when the instructions are executed. However, in some cases, the processing module 105b may be a processor specific device (for example, a mobile terminal or a fixed computing device) configured to employ an embodiment of the present invention by further configuration of the processing module 105b by instructions for performing the algorithms and/or operations described herein. The processing module 105b may include, among other things, a clock, an arithmetic logic unit (ALU) and logic gates configured to support operation of the processing module 105b.

In some embodiments, the processing module 105b may be configured to provide Internet-of-Things (IoT) related capabilities to a user. In some embodiments, the user may be or correspond to a recruiter looking for suitable candidates. In other embodiments, the user may be an organization represented by its talent management team that has different talent management professionals accessing the data management platform 105. The data management platform 105 may be accessed using the communication interface(s) 105a. The communication interface 105a may provide an interface for accessing various features and data stored in the data management platform 105. For example, the communication interface 105a may comprise I/O interface which may be in the form of a GUI, a touch interface, a voice enabled interface, a keypad, a keyboard, a mouse, a display unit, a monitor, and the like. For example, the communication interface 105a may be a touch enabled interface of a server computer or a remote desktop that displays a web interface or web page for the data management platform 105. The data management platform 105 provides various functionalities for data management using the various modules 201-209 described below.

The various modules 201-209 of the processing module 105b, in conjunction with the storage 105c and communication interface 105a may provide capabilities and advantages to the data management 105 to manage data securely and with efficiency, specifically talent acquisition data.

The reception module 201 may be configured to receive one or inputs for processing from the communication interface 105a. The communication interface 105a may thus be configured as an input interface configured to receive an input profile data. The input profile data may be inputted at the computing system 101 that a user accesses and enters details corresponding to the input profile. This input profile is them transmitted as the input profile data to the data management platform 105, where at the input interface associated with the communication interface 105a of the data management platform 105, the input profile data is received and forwarded to the reception module 201 of the processing module 105b. The input profile data may be in the form of a resume, a document containing various fields, a job description, a form submission, and the like. The reception module then forwards the input profile data to the parser module 203 for further processing.

The parser module 203 is configured to parse the input profile data into a standardized profile data format. To that end, the parser module 203 comprises instructions for natural language understanding (NLU) and a corresponding natural language processing (NLP) model, which can convert the input profile data received in any form, to identifiable information of the standardized data format for computer-based processing. For example, the NLP model may be the NER model that converts the input profile data into the standardized profile data format. The standardized profile data format may include data fields such as name of the person, location of the person, designation of the person, working period of the person, education of the person, person information (such as contact details, age, gender, or the like), and the like.

After parsing, the standardized data fields of the standardized profile data format are forwarded for processing to the search module 205. The search module 205 is configured to execute computer-executable instructions to determine, by searching in the database 107, a first set of profile data from the plurality of candidate profiles that are stored in the database 107. The first set of profile data includes one or more profiles that are related to the standardized profile data, which are determined by using the various fields of the standardized profile data as search parameters for a search query directed towards the database 107 for searching. Based on the search, the identified one or more profiles in the first set are arranged based on ranking information. The ranking information provides an order of priority for various data fields in the standardized profile data. For example, some data fields, like full name, social links, emails, or the like, which are more pertinent to identifying a person uniquely, may be provided with highest priority for matching parameters for searched related profiles. On the other hand, data fields like current company name, past company names, educational institutes, location, or the like, may be provided with lowest priority, as this information is bound to change.

Based on the order of priority, the search module 205 outputs the first set of profiles that were identified during search. The searched first set of profiles is then forwarded for processing to the similarity computation module 207.

The similarity computation module 207 is then configured to process each related profile in the first set one by one and assign it a similarity score. The similarity score is computed, by either or a combination of: (i) a trained Machine Learning (ML) model or (ii) a rule-based model, such that the similarity score is associated with a measure of similarity between the standardized profile data and each respective profile data in the first set of profile data. The choice of whether to use the rule-based model or the trained ML model is governed by determining a structure of the standardized profile data, wherein the structure of the profile data is at least one of a simple structure and a complex structure. If the structure is simple, then rule based model is used for similarity score computation, but is the structure is complex (that is with too many fields), then the trained ML model is used for computing the similarity score.

To that end, the similarity computation module 207 further comprises a rule module 207a and an ML module 207b, as illustrated in FIG. 2B. FIG. 2B illustrates another block diagram showing in detail the similarity computation module 207 associated with the data management platform 105 accordance with one or more example embodiments.

The rule module 207a comprises a rule-based model comprises, which is a collection of one or more computer-executable rules for determining a level of similarity of each respective profile data with the standardized profile data. The computer-executable rules may include, for example, if-then-else based scenarios which check various fields of the standardized profile data with the respective fields of each of the profiles in the first set, and then assigns a similarity score to that particular profile based on the number of matches of parameters to parameters. For example, one rule may be checking if the standardized profile data has year of experience as 5 years, then a related or similar profile should have years of experience equal to or lesser than 5 years but greater than 4 years. Such rule-based checking is performed when there are limited number of fields (such as 50 or less) in the standardized data profile, for example. But if structure of standardized data profile is complex, such as more than 50 fields, then rule based checking may be computationally inefficient, and ML based techniques implemented by ML module 207b may be used. For example, if the standardized profile data does not have education information nor working history, then rule-based model is used.

Further, for complex structures profiles, the ML module 207b may be used for similarity computation. The ML module 207b comprises a training module 211, a learning module 213, and a prediction module 215. The ML module 207b embodies a trained ML model, which is trained by the training module using 211 using a training dataset of profile data, which is derived from the plurality of candidate profiles stored in the database 107. The training dataset of profiles is used by the learning module 213 to implement one or more learning algorithms to train the ML module 207b and generate predictions using the prediction module 215. The ML module 207b is further validated using outputted matched profiles of the similarity computation module 207.

The ML module 207b may use any type of learning algorithm in the learning module 213, such as supervised learning, un-supervised learning, or reinforcement-based learning. Further, the learning module 213 may implement any of the machine learning algorithms like linear regression, logistic regression, Support Vector Machines (SVM), neural networks, random forest, principal components analysis, Bayesian classifiers, Fisher discriminant analysis, Gaussian mixture models, genetic algorithms, decision trees, projective likelihood, k-nearest neighbor analysis, function discriminant analysis, predictive learning via rule ensembles, state machines, probabilistic models, expectation-maximization, or hidden and maximum entropy Markov models and the like.

Using any of the learning algorithms, the ML module 207b may be configured to predict an outcome of similarity between the standardized profile data and each of the profiles of the first set. Then, the prediction module 215 may be configured to compute a similarity score based on the level of similarity as predicted.

In some embodiments, the training module 211 is trained offline, that is before an actual input profile is received and computations are performed by the learning module 213 and the prediction module 215. However, in some embodiments, the training module 211 is trained online, such as in real-time, with each similarity score computation.

Irrespective of the manner in which the ML module 207b is trained, the output of the ML module 207b is the similarity score, which is predicted by the prediction module 215, based on the received standardized profile data, each of the profiles in the first set of profiles, and the learning algorithm used in the learning module 215.

The similarity score is then used by the extraction module 209 to extract matched profile data from the first set of profile data based on a comparison of the similarity score with a threshold confidence score. The matched profile data may include one or more profiles based on how many profiles from the first set qualify the comparison check between the similarity score and the threshold confidence score. Based on the comparison, a respective profile data with the similarity score greater than the threshold confidence score is extracted, while another respective profile data with similarity score lesser than the threshold confidence score is removed the first set of profile data. After this extraction processing, the profiles that remain in the first set are the finally matched profiles.

In some embodiments, the remaining matched may further be filtered to extract only the one or more matched profiles with highest similarity score.

Finally, the filtered matched profiles are then used form an update matched profile data, and this updated matched profile replaces the previous matched profile data. These steps of filtering and updating the matched profile data may be performed iteratively for a predefined number of iterations or based on a computational processing limitation parameter. Once the iterative processing is done for specified times or computational limit, the matched profile (dataset) at the end of the iterative processing is identified as the extracted candidate profile for output and is sent to an output interface configured to output the matched profile data as the extracted candidate profile.

The output interface may be the communication interface 105a which transmits the extracted candidate profile to the computing system 101 of the user, where the extracted candidate profile may be displayed on a user interface of the computing system 101.

In this manner, the data management platform 105 may enable to user to efficiently view similar profiles for their given input profile and make further processing decisions, such as hiring, sourcing, messaging candidates, updating their internal database, maintaining their private talent data pools securely, and the like.

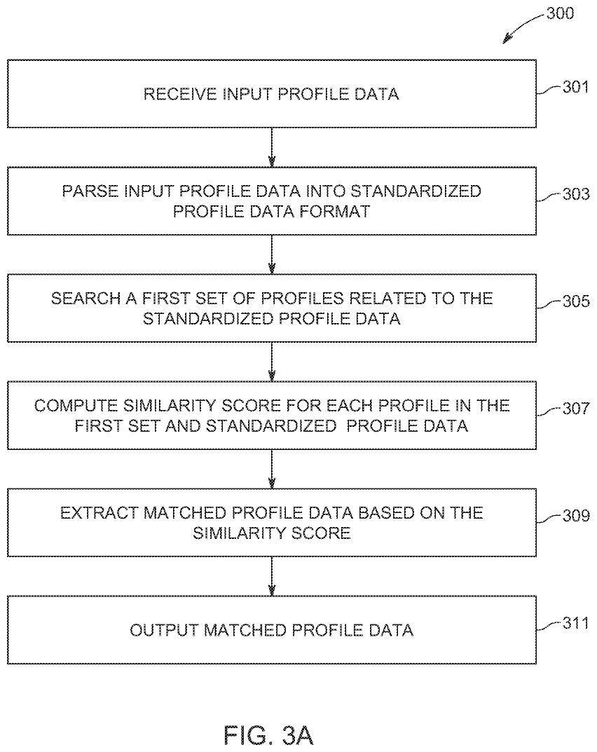

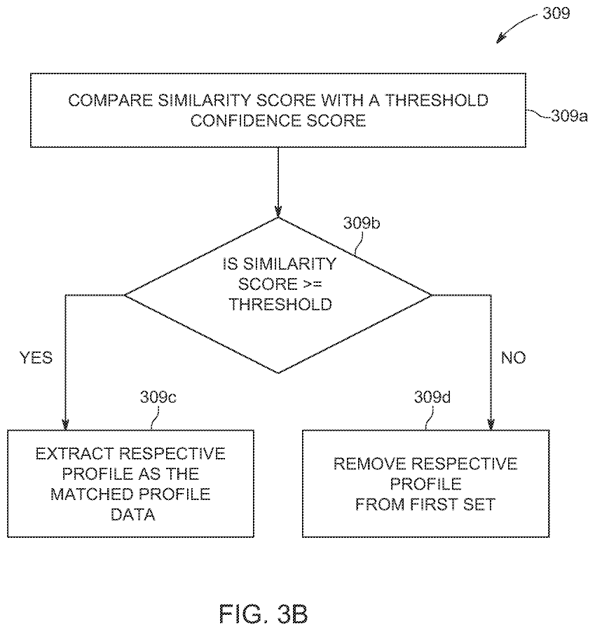

FIG. 3A illustrates a flowchart of a method 300 for managing data in the data management platform 105, according to an embodiment.

In some embodiments, each operation described in each block of the method 300 may be implemented in the form of computer-executable instructions, which are stored in a memory, such as the storage 105c associated with the data management platform 105. Further, the computer-executable instructions when executed, cause the various operations of the method 300 to be performed by at least one processor, such as the processing module 105b associated with the data management platform 105. For example, the processing module 105b may be configured to carry out the operation associated with management of data related to a plurality of candidate profiles stored in the database 107.

The method 300 starts at step 301 with the reception of an input profile data at an input interface associated with the data management platform 105. For example, the communication interface 105a of the data management platform 105 receives the input profile that is transmitted from the computing system 101. For example, a user, such a talent management professional of a company A accesses the computing system 101, such as a desktop, placed in their office and opens a website using a browser, the website corresponding to a URL for a server hosting the data management platform 105. In some embodiments, instead of the website accessed via a browser, the talent management professional may have a desktop client application running on their computing system, with which they access the data management platform 105. After accessing the data management 105 in any of these ways, the communication interface 105a of the data management platform 105 is provided to the user. For example, a website landing page having GUI elements for input, or a GUI of the desktop client application may be displayed to the user.

Thereafter, the user accesses a GUI element for submitting the input profile data on the data management platform 105. For example, the user may upload a resume of a candidate, which they want to use as the input profile data to search similar profiles. Alternatively, the user may select multiple fields displayed in the GUI to enter data about the input profile. The multiple fields may be such as person name, person skills, person education, person location, person age, person experience years, and the like. The user may select these fields using various GUI elements such as forms, drop-down menus, radio buttons, filters, date range/calendar lists and the like. Using either type of submission, the input profile data may be received at the data management platform 105.

Them at step 303, the input profile data may be parsed into a standardized profile data format. For example, the parser module 203 is configured to execute instructions to parse the input profile data into the standardized profile data format. The parser module 203 may be configured to implement an NLP or NLU algorithm for parsing the input profile data. For example, the parser module 203 may execute instructions to implement an NER model, or a sematic analysis model to extract data about named fields from the input profile using text analysis, and parse them into standardized data fields, such as person name, person age, person designation, person education, and the like.

Once the parsing is done, at step 305, a search may be performed in the database 107, to search and identify a first set of profile data from the plurality of candidate profiles stored in the database 107, such that first set of profile data is related to the standardized profile data. For example, the search module 205 is configured to execute instructions for searching related profiles of the standardized profile data from the database 107, using the various fields of the standardized profile data as search parameters, automatically form a search query, and search related profiles. In some embodiments, the different fields may also be given weights to emphasize some fields more and other fields less, while searching. The weighted combination of search fields are then used to search related profiles and return search results in the form of the first set of profile data, which may then be arranged in a priority order based on a ranking information. Further, the first set of profile data, arranged in order of priority may either be displayed on the communication interface 105a, or else, in a preferred embodiment of this disclosure, is sent for further processing. The further processing is performed by the similarity computation module 207.

At step 307, a similarity score is computed for each profile in the first set of profile data, to identify a measure of similarity between the standardized profile data and each respective profile in the first set of profile data. The computation of similarity score may be done by either or a combination of: (i) a trained Machine Learning (ML) model (such as the ML module 207b illustrated in FIG. 2B) or (ii) a rule-based model (such as the rule module 207a illustrated in FIG. 2B). The selection of the type of the model is based on the structure of the standardized profile data. If the structure is simple, such that less fields are there, then the rule-based model may be selected. However, if the structure is complex, that is more fields are there, then the trained ML model may be selected. The choice of the number of fields that determine the complexity, may be a configurable parameter, which may be set based on a number of factors, such as available computing resources, type of system for implementation of the various modules, type of industry where data management is being applied, and the like.

Further, at step 309, a matched profile may be extracted from the first set of profile data based on the similarity score. For this, the similarity score of each profile in the first set of profile data is compared with a threshold confidence score. This is further explained in FIG. 3B. As shown in FIG. 3B, at 309a, the similarity score each profile in the first set of profile data is compared with the threshold confidence score. Then, at 309b, it is determined whether the similarity score of a respective profile is greater than or equal to the threshold confidence score. If yes, then, at 309c, the respective profile is extracted as the matched profile. However, if the similarity score of the respective profile is lesser than the threshold confidence score, then at 309d, the respective profile is removed or deleted from the first set of profile data. The checking shown in step 309 of FIG. 3B is performed iteratively till all the profiles in the set of profile data have been checked against the threshold confidence score.

At the end of checking for all the profiles in the first set of profile data, the one or more profiles that remain in the first set are identified as the matched profile data in some embodiments. In some other embodiments, the profile with the highest similarity score among the profiles with similarity score greater than or equal to the threshold confidence score is extracted as the matched profile data. The threshold confidence score may be a configurable parameter that may be derived based on experimental checking and checking using ground truth data.

After, the extraction of the matched profile data (either as a set or a single profile), at step 311, the matched profile data is outputted as the extracted candidate profile on an output interface, such as the communication interface 105a of the data management platform 105. This output may then be viewed or accessed by the user via their computing system 101 and its associated display interface.

In some embodiments, after outputting the candidate profile data and even otherwise, the data management platform 105 may further be configured to maintain a private talent data pool for the user, on the basis of various fields in the plurality of stored profiles in the database 107 and the fields in the input profile entered by the user.

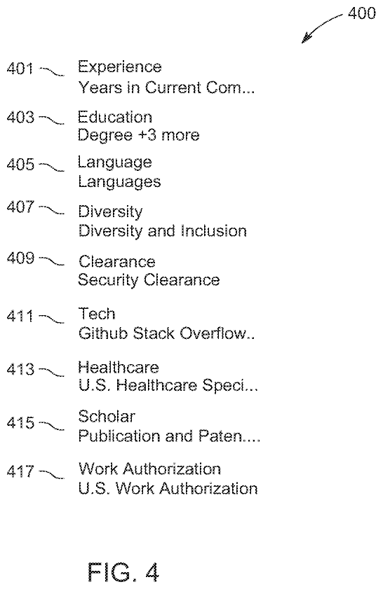

FIG. 4 illustrates a GUI 400 depicting an example set of fields associated with an input profile, in accordance with one or more example embodiments. The GUI 400 may be displayed to the user while entering the input profile. The fields may provide multiple options to the user to select as the criteria for inputting the profile and extracting similar profiles or for creating and/or adding the input profile to the private talent pool of the user. The user may be such as a customer of the data management platform 105. The customer may then select the fields such as an experience 401, education 403, language 405, diversity information 407, security clearance related information 409, technical skills 411, healthcare specialization 413, scholarly publications 415, work authorization information 417 and the like.

When the input profile is received from the customer at the data management platform 105 by selecting any of the fields 401-417, the input profile is converted to the standardized profile data format and then it is checked to see if such a profile with all exact same fields already exists in the database 107. For this, first the method 300 is executed to identify matched profile data for the input profile in the manner described above in previous embodiments, and then further checking for duplicates, for this particular customer is done. If a similar profile already exists, then the database 107 is not updated, else the database 107 is updated to add the input profile to a private talent data pool of the customer, which contained candidate profiles for that particular customer only. This ensures privacy of data for each customer, and also avoids duplicates wherever possible.

In some embodiments, the candidate profiles outside of the customer's private talent data pool are public profiles, which are derived from publicly available information of the candidate, such as on resumes on job portals, social networking sites, professional or business networking sites, in research paper publications, as part of inventor information if published patent applications are available for the candidate, and the like.

The creation of private talent data pool is further described in FIG. 5.

FIG. 5 illustrates a flowchart of a method 500 for creating a private talent pool of data for a customer of the data management platform 105 based on fields comparison, in accordance with one or more example embodiments. The method 500 is triggered when the customer inputting the profile at the input interface of the data management platform 105.

In some embodiments, each operation described in each block of the method 500 may be implemented in the form of computer-executable instructions, which are stored in a memory, such as the storage 105c associated with the data management platform 105. Further, the computer-executable instructions when executed, cause the various operations of the method 500 to be performed by at least one processor, such as the processing module 105b associated with the data management platform 105. For example, the processing module 105b may be configured to carry out the operation associated with management of data related to creation of private talent data pool in the database 107, for the customer.

The method 500 includes, at step 501, conducting computer-executable instructions to identify the customer inputting the input profile data. The customer may be identified using their login information which may associated with their user account created for accessing the data management platform 105. Each user account is associated with a unique user or customer. There may be different types of users which may be identified on the basis of type of user account, which they may opt or choose while registering on the data management platform 105. For example, the different types of user accounts may be a starter user account that does not need any registration fee and provided limited access features to the customer; a standard user account which may have a first nominal fee and provides few extra privileges or access features than the starter account, a professional user account which may have a second nominal fee and provides more access features than the standard account; and an enterprise user account which may have a third nominal fee and may be specifically suited for corporations and enterprises, and provides many access features for the data management platform 105. Once the user is identified as any of the types described above, the access features available for their type of account are identified, and based on this identification, they are further directed to processing foe private talent data pool creation or are notified of extraction of matched profile data without any private talent data management service. For example, the private talent data pool service may be available for the enterprise type of user account in some embodiments.

At step 503, a first set of data fields may be determined on the basis of the standardized profile data. The first set of data fields are the fields such as from the fields 401-417 that are derived from the input profile after converting it into standardized profile data format. For example, the output of the parser module 203 shown in FIG. 2A may be further used by the similarity computation module 207 for identifying the first set of fields.

Similarly, at step 505, a second set of data fields is determined from matched profile data that has been determined based on searching profiles similar to the input profile, and then identifying similarity between each of the searched profiles (the first set of profiles) and the input profile and determining the matched profile data. The second set of data fields may be obtained by first converting the matched profile data into standardized profile data format using the parser module 203 (shown in FIG. 2A), and then determining the fields in the converted matched profile data (into standardized matched profile data) as the second set of data fields.

Further, at step 507, the first set of data fields is compared with the second set of data fields. This comparison may be implemented by the similarity computation module 207 shown in FIG. 2A. Specifically, the trained ML model implemented by the ML module 207b (shown in FIG. 2B) may be configured to conduct the instructions for comparison of the first set of data fields with the second set of data fields.

Further, at step 509, if it is determined that the first set of data fields are different than the second set of data fields, either quantitatively or qualitatively, then creation private talent data pool for the customer inputting the input profile and identified in the step 501 is triggered. Correspondingly, the database 107 is checked to determine if the private talent data pool for the customer already exists. If yes, the input profile is simply added to the private talent data pool, otherwise a new private talent data pool is created for the customer in the database 107.

The private talent data pool comprises one or more profile data (such as corresponding to candidate profiles) that are accessible exclusively to the customer, so that the customer's data is private, secure, and safe from data breach threats. The profiles in the private talent data pool are different from other type of profiles considered as ‘public’ profiles, stored in the database 107. The ‘public’ profiles are obtained by the data management platform 105 from public sources such as open submissions by candidates or recruiters, by crawling the web, through social and business networks, through job forums, communities, and the like.

In some embodiments, the private talent data pool of the customer may contain a profile of a person. The same person's profile may already be present in the database 107 because of extraction from public sources. However, the profile in the private talent data pool may contain information which is not available in the public profile, and that information may be exclusively accessible to the customer in whose private talent data pool the profile is stored. This offers the benefit of data privacy for data of each customer in the data management platform 105.

According to some embodiments, the ML module 207b shown in FIG. 2B may be configured to determine if the input profile data has any data field that is different and/or newly added with respect to the corresponding public profile. If the input profile data has at least one data field that is different and/or newly added with respect to the public profile, the ML module 207b is configured to trigger creation of a private talent data pool for the customer such that the private talent data pool includes the input profile data and the private talent data pool is isolated from other customers. Conversely, if the input profile data does not include any data field that is different and/or newly added with respect to the public profile, then the ML module 207b may not create the private talent data pool. In other words, the ML module 207b may not trigger creation of the private talent data pool if the input profile data is exact match of the public profile. Thereby, the data management platform 105 offers effective memory management and provides optimal reduction in memory requirements for storing of candidate profile data, by avoiding the creation of unnecessary private talent data pool for any customer.

Further, in some embodiments, if a new input profile data is received from the same customer and the new input profile data has at least one data field that is different and/or newly added with respect to a public profile that is similar to the new input profile data, then the new input profile data may be included in the private talent data pool associated with the customer. Accordingly, the data management platform 105 may provide data security for the customers by creating their private talent data pool when needed.

Additionally or alternatively, if an input profile data received from one customer is similar to another input profile data received from another customer, then a private talent data pool for a customer may be created by comparing the input profile data received from both the customers. An example of creation of the private talent data pool for a customer A, by comparing the input profiles received from the customer A and another customer B is as illustrated in FIGS. 6A-6C.

FIGS. 6A-6C illustrate graphical user interfaces (GUIs) depicting sample profile data stored in the data management platform 105 for different customers, in accordance with one or more example embodiments.

FIG. 6A illustrates an example GUI 600a associated with a first input profile data received from the customer A for a person named Chia Dai. The first input profile data includes a first set of data fields 601 corresponding to contact information of the person.

FIG. 6B illustrates an example GUI 600b associated with the same first input profile data received a second time from the customer A for the same person, Chia Dai, and having the first set of data fields 601 for the contact information and an additional resume file 603.

FIG. 6C on the other hand illustrates an example GUI 600c associated with a second input profile of the same person named Chia Dai, but this time received from a second customer, the customer B. The second input profile includes a third set of data fields 605 for the contact information. As can be seen from the input profile shown in GUI 600c, the third set of data fields 605 includes lesser information in the contact information, as compared to the first set of data fields 601, by virtue of not having two email ids mentioned in the first set of data fields.

Thus, the data management platform 105 ensures complete data privacy among data of different customers by maintaining their private talent data pools, which contain profiles that have information exclusively available for the customer in whose private talent data pool the profile is saved. As can be seen from FIG. 6A and FIG. 6B, that the first input profile of the person named Chia Dai has exclusive information of email ids in the first set of data fields 601 and resume in second set of data fields, which is available only to customer A, as the first input profile is stored in the private talent data pool of the customer A. But the customer A and the customer B can anytime access all the data fields for the person named Chia Dai, which available publicly and stored in their public profile in the database 107.

In this manner, the data management platform 105 ensures secure, isolated, effective, and up to date data management for profile data stored in database 107, without requiring too much memory resources. A user can access the services of the data management platform 105 described in all the previous embodiments by using their computing system 101, which is described in FIG. 7 below.

FIG. 7 illustrates a block diagram of the computing system 101 used for implementation of the system discussed in previous figures for accessing the services of the data management platform 105.

The computing system 101 includes an input interface 101a, at least one processor 101b, a memory 101c, an output interface 101a, and a network interface controller 101e, all components being interconnected by a bus for passing information.

The processor 101b executes computer-executable instructions, such as for accessing the data management platform 105 via one or more Application Programming Interface (API) calls, or via one or more network communication protocol messages. The processor 101b can include a general-purpose processor, a special-purpose processor, and combinations thereof. For example, the processor 101b can include a general-purpose central processing unit (CPU), a graphics processor, a processor in an application-specific integrated circuit (ASIC), a processor configured to operate using programmable logic (such as in a field-programmable gate array (FPGA)), and/or any other type of processor. In a multi-processing system, multiple processing units can be used to execute computer-executable instructions to increase processing power.

The memory 101c stores software implementing one or more innovations described herein, in the form of computer-executable instructions suitable for execution by the processor 101b. Specifically, the memory 101c can be used to store computer-executable instructions, data structures, input data, output data, and other information. The memory 101c can include volatile memory (e.g., registers, cache, random-access memory (RAM)), non-volatile memory (e.g., read-only memory (ROM), electrically erasable programmable ROM (EEPROM), and flash memory), and/or combinations thereof. The memory 101c can include operating system software (not illustrated). Operating system software can provide an operating environment for other software executing in the computing system 101 and can coordinate activities of the components of the computing system 101.

The computing system 101 may additionally include storage (not shown separately) that can include electronic circuitry for reading and/or writing to removable or non-removable storage media using magnetic, optical, or other reading and writing system that is coupled to the processor 101b. The storage can include read-only storage media and/or readable and writeable storage media, such as magnetic disks, solid state drives, magnetic tapes or cassettes, CD-ROMs, CD-RWs, DVDs, or any other medium which can be used to store information and that can be accessed within the computing system 101.

The computing system 101 may include the network interface controller 101e for communicating with another computing entity using a communication medium (e.g., the network 103 shown in FIG. 1).

The computing system 101 may include the input interface 101a for interfacing with and receiving input signals from input device(s) from a physical environment. The input device(s) can include a tactile input device (e.g., a keyboard, a mouse, or a touchscreen), a microphone, a camera, a sensor, or another device that provides input to the computing system 101.

The computing system 101 may include the output interface 101d to provide an output interface to a user of the computing system 101 and/or to generate an output observable in a physical environment using output device(s). The output device(s) can include a light-emitting diode, a display, a printer, a speaker, a CD-writer, or another device that provides output from the computing system 101. In some examples, the input device(s) and the output device(s) may be used together to provide a user interface to a user of the computing system 101.

The computing system 101 is not intended to suggest limitations as to scope of use or functionality of the technology, as the technology can be implemented in diverse general-purpose and/or special-purpose computing environments. For example, the disclosed technology can be practiced in a local, distributed, and/or network-enabled computing environment. In distributed computing environments, tasks are performed by multiple processing devices. Accordingly, principles and advantages of distributed processing, such as redundancy, parallelization, and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, Packet Data Networks (PDNs), the Internet, intranets, and combinations thereof.

The term computer-readable media includes non-transient media for data storage, such as memory 101c and storage 105c (shown in FIG. 2A) and does not include transmission media such as modulated data signals and carrier waves. Any of the disclosed methods can be implemented as computer-executable instructions stored on one or more computer-readable media and executed on a computer (e.g., any commercially available computer). Any of the computer-executable instructions for implementing the disclosed techniques as well as any data structures and data created and used during implementation of the disclosed embodiments can be stored on one or more computer-readable storage media. For example, the computer-executable instructions can be part of a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, or other such network) using one or more network-attached computers.

Accordingly, blocks of the methods shown by flow diagrams support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for extracting candidate data from a database storing a plurality of candidate profiles, the system comprising:
an input interface configured to receive an input profile data;
a memory for storing computer executable instructions;
at least one processor configured to execute the computer executable instructions to:
parse the input profile data into a standardized profile data format;
determine, by searching in the database, a first set of profile data from the plurality of candidate profiles, which is related to the standardized profile data;
compute, by either or a combination of: (i) a trained Machine Learning (ML) model or (ii) a rule-based model, a similarity score for each profile data in the first set of profile data, such that the similarity score is associated with a measure of similarity between the standardized profile data and each respective profile data in the first set of profile data; and
extract matched profile data from the first set of profile data based on a comparison of the similarity score with a threshold confidence score; and
an output interface configured to output the matched profile data as the extracted candidate profile.

2. The system of claim 1, wherein computing the similarity score further comprises:
determining a structure of the standardized profile data, wherein the structure of the profile data is at least one of a simple structure and a complex structure; and
computing the similarity score by either or a combination of: (i) a trained Machine Learning (ML) model, (ii) a rule-based model, based on the determined structure.

3. The system of claim 1, wherein the rule-based model comprises one or more computer-executable rules for determining a level of similarity of each respective profile data with the standardized profile data.

4. The system of claim 1, wherein the trained ML model comprises:
a computer-executable ML model stored in the memory, such that the ML model is trained using:
a training dataset of profile data, which is derived from the plurality of candidate profiles stored in the database and the outputted matched profile.

5. The system of claim 1, wherein extracting the matched profile comprises:
comparing the similarity score of each respective profile data of the first set of profile data with the threshold confidence score; and
extracting a respective profile data with the similarity score greater than the threshold confidence score as the matched profile.

6. The system of claim 5, wherein the at least one processor is further configured to remove a respective profile from the first set of profile data when the similarity score of the respective profile is lesser than the threshold confidence score.

7. The system of claim 1, wherein the database comprises the plurality of candidate profiles associated with talent acquisition data.

8. The system of claim 1, wherein the standardized profile data format comprises one or a combination of data fields selected from: a name of a person, location of the person, designation of the person, working period of the person, education of the person, contact details of the person, age of the person, and gender of the person.

9. The system of claim 1, wherein the at least one processor is further configured to execute the computer-executable instructions to:
identify a customer inputting the input profile data;
determine a first set of data fields associated with the standardized profile data;
determine a second set of data fields associated with the matched profile data;
compare, using the trained ML model, the first set of data fields with the second set of data fields; and
creating a private talent pool of data for the customer in the database, when the comparison indicates a difference in the first set of data fields and the second set of data fields.

10. A method for extracting candidate data from a database storing a plurality of candidate profiles, the method comprising:
receiving, at an input interface, an input profile data;
parsing the input profile data into a standardized profile data format;
determining, by searching in the database, a first set of profile data from the plurality of candidate profiles, which is related to the standardized profile data;
computing, by either or a combination of: (i) a trained Machine Learning (ML) model or (ii) a rule-based model, a similarity score for each profile data in the first set of profile data, such that the similarity score is associated with a measure of similarity between the standardized profile data and each respective profile data in the first set of profile data;
extracting matched profile data from the first set of profile data based on a comparison of the similarity score with a threshold confidence score; and
outputting, at an output interface, the matched profile data as the extracted candidate profile.

11. The method of claim 10, wherein computing the similarity score further comprises:
determining a structure of the standardized profile data, wherein the structure of the profile data is at least one of a simple structure and a complex structure; and
computing the similarity score by either or a combination of: (i) a trained Machine Learning (ML) model or (ii) a rule-based model, based on the determined structure.

12. The method of claim 10, wherein the trained ML model comprises:
a computer-executable ML model stored in a memory, such that the ML model is trained using:
a training dataset of profile data, which is derived from the plurality of candidate profiles stored in the database and the outputted matched profile.

13. The method of claim 10, wherein extracting the matched profile comprises:
comparing the similarity score of each respective profile data of the first set of profile data with the threshold confidence score; and
extracting a respective profile data with the similarity score greater than the threshold confidence score as the matched profile.

14. The method of claim 13, further comprising removing a respective profile from the first set of profile data when the similarity score of the respective profile is lesser than the threshold confidence score.

15. The method of claim 10, wherein the standardized profile data format comprises one or a combination of data fields selected from: a name of a person, location of the person, designation of the person, working period of the person, education of the person, contact details of the person, age of the person, and gender of the person.

16. The method of claim 10, further comprising:
identifying a customer inputting the input profile data;
determining a first set of data fields associated with the standardized profile data;
determining a second set of data fields associated with the matched profile data;
comparing, using the trained ML model, the first set of data fields with the second set of data fields; and
creating a private talent pool of data for the customer in the database, when the comparison indicates a difference in the first set of data fields and the second set of data fields.

17. A computer program product comprising a non-transitory computer readable medium having stored thereon computer executable instruction which when executed by at least one processor, cause the at least one processor to conduct operations for extracting candidate data from a database storing a plurality of candidate profiles, the operation comprising:
receiving, at an input interface, an input profile data;
parsing the input profile data into a standardized profile data format;
determining, by searching in the database, a first set of profile data from the plurality of candidate profiles, which is related to the standardized profile data;
computing, by either or a combination of: (i) a trained Machine Learning (ML) model or (ii) a rule-based model, a similarity score for each profile data in the first set of profile data, such that the similarity score is associated with a measure of similarity between the standardized profile data and each respective profile data in the first set of profile data;
extracting matched profile data from the first set of profile data based on a comparison of the similarity score with a threshold confidence score; and
outputting, at an output interface, the matched profile data as the extracted candidate profile.

18. The computer program product of claim 17, wherein for computing the similarity score, the operations further comprise:
determining a structure of the standardized profile data, wherein the structure of the profile data is at least one of a simple structure and a complex structure; and
computing the similarity score by either or a combination of: (i) a trained Machine Learning (ML) model or (ii) a rule-based model, based on the determined structure.

19. The computer program product of claim 17, wherein for extracting the matched profile, the operations further comprise:
comparing the similarity score of each respective profile data of the first set of profile data with the threshold confidence score; and
extracting a respective profile data with the similarity score greater than the threshold confidence score as the matched profile.

20. The computer program product of claim 17, wherein the operations further comprise:
determining a first set of data fields associated with the standardized profile data;
determining a second set of data fields associated with the matched profile data;
comparing, using the trained ML model, the first set of data fields with the second set of data fields; and
creating a private talent pool of data for the customer in the database, when the comparison indicates a difference in the first set of data fields and the second set of data fields.
